(19) United States
(12) Patent Application Publication
(10) Pub. No.: US 2015/0030810 A1
(43) Pub. Date: Jan. 29, 2015

(54) POROUS SUCTION SHEET AND REPLACEABLE SURFACE LAYER USED THEREIN

(71) Applicant: NITTO DENKO CORPORATION, Ibaraki-shi, Osaka (JP)

(72) Inventors: Katsuki Tsukamoto, Osaka (JP); Toshimitsu Tachibana, Ibaraki-shi (JP)

(21) Appl. No.: 14/376,777

(22) PCT Filed: Feb. 15, 2013
(86) PCT No.: PCT/JP2013/000848

§ 371 Date: Aug. 5, 2014

(30) Foreign Application Priority Data
Feb. 17, 2012 (JP) 2012-032412

(51) Int. Cl. B32B 5/30; B32B 27/32

(52) U.S. Cl. CPC B32B 5/30; B32B 27/32; B32B 2250/03; B32B 2264/0257; B32B 2305/026; B32B 2307/724
USPC 428/147

(57) ABSTRACT

Provided is a multilayer porous suction sheet having an unprecedented structure to prevent contact between a suction object and a suction surface of a suction unit when the sheet is disposed on the suction surface. The porous suction sheet includes a base layer having air permeability and a surface layer disposed on the base layer. The surface layer is made of a porous body composed of resin fine particles that are bonded together, one principal surface of the surface layer opposite to the other principal surface facing the base layer has a surface roughness (Ra) of 1.0 μm or less, and the base layer and the surface layer are coupled together by an air-permeable adhesive layer disposed between the base layer and the surface layer. The base layer and/or the surface layer is made of, for example, ultrahigh molecular weight polyethylene (UHMWPE).

### TECHNICAL FIELD

The present invention relates to a porous suction sheet that prevents direct contact between a suction object and a suction surface of a suction unit when the sheet is disposed on the suction surface. The present invention also relates to a replaceable surface layer used in the porous suction sheet.

### BACKGROUND ART

One of the techniques for holding or transferring plate-like or sheet-like components is to keep the components by suction on a suction surface of a suction unit so as to hold or transfer them. This method is applied to holding and transfer of glass sheets (for example, glass substrates for liquid crystal display devices), semiconductor wafers, ceramic green sheets, etc. In the method, a porous air-permeable suction sheet is usually disposed on a suction surface of a suction unit to prevent direct contact between the suction unit and a suction object to be sucked onto the suction unit. The porous suction sheet disposed on the suction surface can prevent scratches and contamination on the suction surface caused by, for example, a material constituting the suction object (such as a ceramic powder contained in a ceramic green sheet). The scratches and contamination on the suction surface of the suction unit cause failure of the suction object to be sucked later on the suction surface.

The porous suction sheet is typically a resin sheet. It is proposed to use an ultrahigh molecular weight polyethylene (UHMWPE) sheet having a viscosity average molecular weight of 500,000 or more as a porous suction sheet (Patent Literature 1).

Patent Literature 2 discloses a multilayer porous suction sheet. The porous suction sheet of Patent Literature 2 includes a porous layer and a particle layer disposed on at least one surface of the sheet, and the particle layer has a surface roughness (Ra) of 0.5 μm or less.

### CITATION LIST

### Patent Literature

Patent Literature 1: JP 08(1996)-169971 A

Patent Literature 2: JP 2006-026981 A

### SUMMARY OF INVENTION

### Technical Problem

It is an object of the present invention to provide a multilayer porous suction sheet having an unprecedented structure.

### Solution to Problem

The porous suction sheet of the present invention is a porous suction sheet that prevents contact between a suction object and a suction surface of a suction unit when the sheet is disposed on the suction surface. This porous suction sheet includes a base layer having air permeability and a surface layer disposed on the base layer. The surface layer is made of a porous body composed of resin fine particles that are bonded together. One principal surface of the surface layer opposite to the other principal surface facing the base layer has a surface roughness (Ra) of 1.0 μm or less. The base layer and the surface layer are coupled together by an air-permeable adhesive layer disposed between the base layer and the surface layer.

In the porous suction sheet of the present invention, the base layer and the surface layer are coupled together by the air-permeable adhesive layer. Therefore, the base layer and the surface layer can be separated from each other to replace the surface layer by a new one, with minimal damage to the base layer. Focusing on the surface layer to be replaced (i.e., a replaceable surface layer used in a porous suction sheet), the replaceable surface layer of the present invention is a replaceable surface layer used in a porous suction sheet. The porous suction sheet prevents contact between a suction object and a suction surface of a suction unit when the sheet is disposed on the suction surface, the surface layer is used to form the porous suction sheet by being coupled to a base layer having air permeability, and the surface layer serves as a surface of the formed porous suction sheet that contacts the suction object when the porous suction sheet is disposed on the suction surface. The surface layer is made of a porous body composed of resin fine particles that are bonded together. An air-permeable adhesive layer is disposed on one principal surface of the surface layer so as to couple the surface layer and the base layer together. The other principal surface of the surface layer has a surface roughness (Ra) of 1.0 μm or less.

### Advantageous Effects of Invention

According to the present invention, it is possible to obtain a multilayer porous suction sheet having an unprecedented structure.

### BRIEF DESCRIPTION OF DRAWINGS

FIG. 1 is a cross-sectional view showing schematically an example of a porous suction sheet of the present invention.

### DESCRIPTION OF EMBODIMENTS

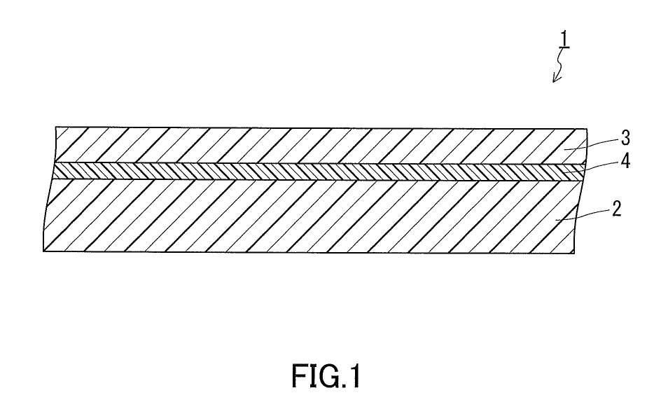

FIG. 1 illustrates an example of the porous suction sheet of the present invention. A porous suction sheet 1 shown in FIG. 1 includes a base layer 2 and a surface layer 3 disposed on the base layer 2. The base layer 2 and the surface layer 3 are coupled together by an air-permeable adhesive layer 4 disposed between the base layer 2 and the surface layer 3. The base layer 2 has air permeability, the surface layer 3 is made of a porous body composed of resin fine particles that are bonded together, and the adhesive layer 4 has air permeability. The porous adhesive sheet 1 disposed on the suction surface of the suction unit makes it possible to keep a suction object by suction on the suction unit while preventing direct contact between the suction object and the suction surface. In this case, the porous suction sheet 1 is disposed on the suction surface so that the surface layer 3 contacts the suction object.

One principal surface of the surface layer 3 opposite to the other principal surface facing the base layer 2 has a surface roughness (Ra) of 1.0 μm or less. That is, the surface of the porous suction sheet 1 that is to contact the suction object has high surface smoothness. This smooth surface suppresses the deformation and distortion of the suction object and the transfer of the surface shape of the porous suction sheet onto the suction object, at the time of suction of the suction object (hereinafter referred simply as “at the time of suction”). These effects are particularly pronounced when a thin suction object such as a ceramic green sheet is sucked. The surface roughness (Ra) of this principal surface is preferably 0.5 μm or less.

In the porous suction sheet 1, the base layer 2 and the surface layer 3 are coupled together by a coupling strength (adhesive strength) provided by the air-permeable adhesive layer 4. This makes it possible to separate the base layer 2 and the surface layer 3 from each other while minimizing the damage to the base layer 2, and thus to make the surface layer 3 replaceable. Even at the time of suction when high pressure is applied to the porous suction sheet 1, the viscoelasticity of the air-permeable adhesive layer 4 can be used to reduce the adverse effect of the irregularities of the surface of the base layer 2 on the smoothness of the above-mentioned principal surface of the surface layer 3 and thus to maintain the high surface smoothness of the porous suction sheet. On the other hand, in a conventional multilayer porous suction sheet, for example, in the porous suction sheet of Patent Literature 2, these effects cannot be obtained because the porous layer and the particle layer are coupled together by heat fusion (sintering). In the conventional multilayer porous suction sheet, it is difficult to separate the porous layer and the particle layer without damaging the porous layer and/or the particle layer, and the irregularities of the surface of the porous layer are likely to significantly affect the smoothness of the surface of the particle layer at the time of suction.

The replaceability of the surface layer 3 is particularly advantageous when the suction of the suction object is performed with heating and/or pressing. For example, in the suction of ceramic green sheets, when they are transferred by suction and laminated, heating and pressing are sometimes performed to secure the adhesive strength between the laminated sheets. In this case, the porous suction sheet is susceptible to damage, such as deformation and fracture, by heat and pressure, and such damage tends to be concentrated near the surface of the porous suction sheet that is in contact with the ceramic green sheets. Conventionally, the entire porous suction sheet needs to be replaced even if only the surface thereof is damaged. However, if the surface layer 3 is replaceable, the entire porous suction sheet does not necessarily need to be replaced, and therefore the productivity of products using the suction objects is improved.

The surface layer 3 is made of a porous body composed of resin fine particles that are bonded together and has air permeability (air permeability in a direction perpendicular to the principal surfaces of this surface layer). The surface layer 3 is formed, for example, by sintering the resin fine particles. The resin fine particles constituting the surface layer 3 are, for example, fine particles that are bonded (sintered) together by heat fusion to form a porous body. Specific examples thereof include fine particles of polyethylene, ultrahigh molecular weight polyethylene (UHMWPE), and polypropylene. Preferably, the resin fine particles constituting the surface layer 3 include UHMWPE fine particles, and more preferably the resin fine particles constituting the surface layer 3 are UHMWPE fine particles, because UHMWPE fine particles are highly resistant to pressure applied at the time of suction (highly resistant to impact), their releasability from the suction object is excellent, and their particle shape can be easily maintained at the time of sintering and thus a uniform and stable porous body can be easily obtained. UHMWPE refers to a polyethylene having a viscosity average molecular weight of 500,000 or more. Preferably, the viscosity average molecular weight of the UHMWPE is 1,000,000 or more to obtain the surface layer 3 having high abrasion resistance.

The average pore diameter of the surface layer 3 is preferably 1 to 25 μm. This range of the average pore diameters suppresses the deformation of the suction object at the time of suction. If the average pore diameter of the surface layer 3 is too small, the air permeability of the surface layer 3 decreases, which may make it difficult to use the resulting sheet as a porous suction sheet. If the average pore diameter of the surface layer 3 is too large, the air permeability of the surface layer 3 increases, but it is difficult for the principal surface of the surface layer 3 that is to contact the suction object to have a surface roughness (Ra) of 1.0 μm or less. In addition, since the density of the bonding sites between the resin fine particles decreases, the strength of the surface layer 3 decreases, which may make it difficult to use the resulting sheet as a porous suction sheet.

The surface layer 3 can be formed, for example, by dispersing the resin fine particles in a solvent to prepare a dispersion, applying the dispersion onto the smooth surface of a carrier film to form a coating layer, and then heating the coating layer to volatilize the solvent and sinter the resin fine particles. More specifically, the surface layer 3 can be formed by the method described, for example, in JP 2010-247446 A. The method described in JP 2010-247446 A can be applied to the formation of the surface layer 3 using resin fine particles other than UHMWPE fine particles.

The average particle diameter of the resin fine particles used to form the surface layer 3 is preferably 10 to 200 μm, and more preferably 20 to 100 μm. If the average particle diameter of the resin fine particles is too small, the average pore diameter of the resulting surface layer 3 is also too small, which may make it impossible for the surface layer 3 to have sufficient air permeability. If the average particle diameter of the resin fine particles is too large, the average pore diameter of the resulting surface layer 3 is also too large, which may make it difficult for the principal surface of the surface layer 3 that is to contact the suction object to have a surface roughness of 1.0 μm or less. In addition, the strength of the surface layer 3 decreases, which may make it difficult to use the resulting sheet as a porous suction sheet.

The thickness of the surface layer 3 is preferably 20 to 500 μm. If the thickness of the surface layer 3 is too small, the strength of the surface layer 3 decreases, which may make it difficult to use the resulting sheet as a porous suction sheet. If the thickness of the surface layer 3 is too large, the air permeability of the surface layer 3 decreases, which may make it difficult to use the resulting sheet as a porous suction sheet. In addition, since the surface layer 3 alone has sufficient strength, the advantages of the multilayer structure of the porous suction sheet are reduced.

The structure of the base layer 2 is not limited as long as the base layer 2 has air permeability (air permeability in a direction perpendicular to its principal surfaces) and has enough flexibility to be used in the porous suction sheet 1. The base layer 2 is, for example, a porous body formed by sintering resin fine particles. In this case, the resin fine particles constituting the base layer 2 are, for example, fine particles that can be bonded (sintered) together by heat fusion to form a porous body. Specific examples thereof include fine particles of polyethylene, UHMWPE, and polypropylene. The UHMWPE fine particles are preferable because the UHMWPE fine particles are highly resistant to pressure applied at the time of suction (highly resistant to impact) and their particle shape can be easily maintained at the time of sintering and thus a uniform and stable base layer can be easily obtained. In this case, the base layer 2 is made of UHMWPE. The base layer 2 preferably contains UHMWPE, and more preferably consists of UHMWPE.

In the case where the base layer 2 is made of a porous body, the average pore diameter of the base layer 2 is preferably 10 to 50 μm because its air permeation resistance at the time of suction decreases. If the average pore diameter of the base layer 2 is too small, the air permeability of the base layer 2 decreases, which may make it difficult to use the resulting sheet as a porous suction sheet. If the average pore diameter of the base layer 2 is too large, the air permeability of the base layer 2 increases, but the strength of the base layer 2 decreases, which may make it difficult to use the resulting sheet as a porous suction sheet.

The base layer 2 can be formed, for example, by subjecting the resin fine particles filled in a mold to heat treatment and performing a cutting process on the resulting porous body block with a lathe or the like. After the cutting process, another heat treatment can be performed to eliminate the stress of the base layer thus formed, if necessary. The shape of the mold is not particularly limited. The cutting process may be omitted by preparing in advance a mold having a depth corresponding to the desired thickness of the base layer 2.

The average particle diameter of the resin fine particles used to form the base layer 2 is preferably 10 to 500 μm, and more preferably 20 to 250 μm. If the average particle diameter of the resin fine particles is too small, the average pore diameter of the resulting base layer 2 is also too small, which may make it impossible for the base layer 2 to have sufficient air permeability. If the average particle diameter of the resin fine particles is too large, the average pore diameter of the resulting base layer 2 is also too large, and the strength of the base layer 2 decreases, which may make it difficult to use the resulting sheet as a porous suction sheet.

The thickness of the base layer 2 is preferably 80 to 5000 μm. If the thickness of the base layer 2 is too small, the strength of the base layer 2 decreases, which may make it difficult to use the resulting sheet as a porous suction sheet. If the thickness of the base layer 2 is too large, the air permeability of the base layer 2 decreases, which may make it difficult to use the resulting sheet as a porous suction sheet. Further, in this case, the leakage through the side surfaces of the base layer increases at the time of suction, which may make it difficult to suck the suction object.

In the porous suction sheet 1, it is preferable that the average pore diameter and the thickness of the base layer 2 be different from those of the surface layer 3. That is, it is preferable that the porous suction sheet 1 have a configuration in which two types of layers (the base layer 2 and the surface layer 3) having different average pore diameters and different thicknesses are coupled together by the air-permeable adhesive layer 4.

In the porous suction sheet 1, it is preferable that the thickness of the surface layer 3 be smaller than that of the base layer 2. In this case, it is easy to separate the base layer 2 and the surface layer 3 when the surface layer 3 is replaced. In addition, since the thickness of the base layer 2 is relatively large, the life of the base layer 2 can be extended.

In the porous suction sheet 1, it is preferable that the base layer 2 be made of a porous body and that the average pore diameter of the surface layer 3 be smaller than that of the base layer 2. In this case, the air permeability and the surface smoothness are well balanced in the porous suction sheet 1. It is also possible to reduce the proportion of the adhesive remaining in the base layer 2 when the base layer 2 and the surface layer 3 are separated to replace the surface layer 3. In order to extend the life of the base layer 2, it is preferable to reduce the proportion of the adhesive remaining in the base layer 2 when the surface layer 3 is separated therefrom. Specifically, it is preferable that when the amount of the adhesive contained in the porous suction sheet 1 including the base layer 2 and the surface layer 3 that are coupled together is 100 wt. %, the proportion of the adhesive remaining in the surface layer 3 be 60 wt. % or more (the proportion of the adhesive remaining in the base layer 2 be 40 wt. % or less) after the base layer 2 and the surface layer 3 are separated from each other.

The air-permeable adhesive layer 4 is a layer having air permeability (air permeability in a direction perpendicular to the principal surfaces thereof) and made of a heat-sensitive or pressure-sensitive adhesive. In the porous suction sheet 1, the base layer 2 and the surface layer 3 are coupled together by the air-permeable adhesive layer 4. Therefore, unlike the case where these layers 2 and 3 are bonded together with another type of adhesives or by heat fusion (sintering), the surface layer 3 is replaceable.

Usually, the adhesive itself does not have air permeability. Therefore, in the air-permeable adhesive layer 4, it is preferable that the adhesive be placed with gaps where no adhesive is present so as to ensure the air permeability of the porous suction sheet 1, rather than that the adhesive covers the entire principal surfaces of the base layer 2 and the surface layer 3 as viewed in the direction perpendicular to the principal surfaces thereof. The air permeability of the porous suction sheet 1 is ensured at least by the gaps where no adhesive is present. In the air-permeable adhesive layer 4, for example, the adhesive is placed in the form of stripes, dots, or fibers as viewed in the direction perpendicular to the principal surfaces of the base layer 2 and the surface layer 3. The air-permeable adhesive layer 4 configured as such can be formed, for example, by spraying the adhesive. In this case, it is preferable to spray the adhesive once onto a release film and then transfer the air-permeable adhesive layer 4 formed on the release film onto the base layer 2 or the surface layer 3, rather than to spray the adhesive directly onto the base layer 2 or the surface layer 3. When the adhesive is sprayed directly onto the base layer 2 or the surface layer 3, the adhesive penetrates into the pores of the base layer 2 or the surface layer 3, which makes it difficult to control the amount of the adhesive to be placed on the surface of that layer. In addition, the layer may be clogged with the sprayed adhesive, which may result in a decrease in the air permeability.

It is preferable to regulate the manner of placement of the adhesive in the air-permeable adhesive layer 4 and the amount of the adhesive placed therein in order to prevent separation between the base layer 2 and the surface layer 3 at the time of suction using the porous suction sheet 1. Furthermore, given that the surface layer 3 is replaced, it is preferable to regulate the manner of placement of the adhesive and the amount thereof to prevent separation between the base layer 2 and the surface layer 3 at the time of suction but to allow separation between them with minimal damage to the base layer 2 at the time of replacement of the surface layer 3.

The amount of the adhesive in the air-permeable adhesive layer 4 is, for example, 1.5 to 15 g/m², and preferably 5 to 10 g/m². In the case where the air-permeable adhesive layer 4 is formed by spraying the adhesive, the amount of the adhesive applied is usually equal to the amount of the adhesive in the air-permeable adhesive layer 4. The amount of the adhesive applied is, for example, 3 to 15 g/m², and preferably 5 to 10 g/m².

Preferably, the coupling strength between the base layer 2 and the surface layer 3 provided by the air-permeable adhesive layer 4 is 0.5 N/25 mm or more in terms of a value measured in accordance with the “method for measuring the 180° peel adhesive strength” specified in JIS Z 0237. In this case, the separation between the base layer 2 and the surface layer 3 at the time of suction is suppressed. The upper limit of the coupling strength is not particularly limited. However, given that the surface layer 3 is replaced, the coupling strength is preferably 5.0 N/25 mm or less because the base layer 2 is less likely to be damaged when the base layer 2 and the surface layer 3 are separated. The coupling strength is preferably 0.5 N/25 mm or more and 5.0 N/25 mm or less, more preferably 0.5 N/25 mm or more and 3.0 N/25 mm or less, and further preferably OM N/25 mm or more and 3.0 N/25 mm or less.

The type of the adhesive constituting the air-permeable adhesive layer 4 is not particularly limited. Examples of the adhesive includes: acrylic-based adhesives; silicone-based adhesives; urethane-based adhesives; ethylene-vinyl alcohol copolymer (EVA)-based adhesives; polyolefin-based adhesives; styrene-based block polymer adhesives composed of polystyrene as a hard segment and, as a soft segment, a chain of one or more selected from polybutadiene, hydrogenated polybutadiene, polyisoprene, hydrogenated isoprene, polybutylene, hydrogenated polybutylene, polyethylene, polypropylene, and polystyrene; synthetic rubber-based adhesives; polyester-based adhesives such as polyethylene terephthalate, polybutylene terephthalate, and unsaturated polyester; polyamide-based adhesives (for example, dimer acid-based polyamide); and phenol-based adhesives. These various types of adhesives and mixture-type adhesives containing these adhesives as main components can be used. More preferably, hot melt agents consisting of the above-mentioned components and mixture-type hot melt agents containing the above-mentioned components as main components can be used.

The porous suction sheet 1 can be formed by an arbitrary method using the base layer 2, the surface layer 3, and the air-permeable adhesive layer 4 or an adhesive serving as the air-permeable adhesive layer 4. For example, it is possible to form the air-permeable adhesive layer 4 by spraying an adhesive onto the surface of the base layer 2 (or the surface layer 3) and then press the surface layer 3 (or the base layer 2) onto the air-permeable adhesive layer 4 so as to couple the base layer 2 and the surface layer 3 together. As described above, it is preferable to form the air-permeable adhesive layer 4 separately by spraying an adhesive onto a release film. However, in this case, it is preferable to first laminate the air-permeable adhesive layer 4 thus formed onto the surface layer 3, remove the release film, and then laminate the base layer 2 onto the air-permeable adhesive layer 4. In the case where the porous suction sheet 1 is formed by this procedure, the air-permeable adhesive layer 4 is bonded more strongly to the surface layer 3 than to the base layer 2 because the air-permeable adhesive layer 4 is laminated onto the surface layer 3 before it is laminated onto the base layer 2. Therefore, when the surface layer 3 is replaced, it is possible to reduce the proportion of the adhesive remaining in the base layer 2 after the separation of the base layer 2 and the surface layer 3. This effect is more pronounced when the average pore diameter of the surface layer 3 is smaller than that of the base layer 2 because an effect of anchoring the adhesive is more likely to occur in the surface layer 3. Since the base layer 2 is used repeatedly even after the surface layer 3 is replaced by a new one, a decrease in the proportion of the adhesive remaining in the base layer 2 makes it possible to suppress a decrease in the air permeability of the base layer 2 and avoid rendering the resulting sheet unusable as a porous suction sheet or to suppress a decrease in the surface smoothness of the new surface layer 3 due to the irregularities of the surface of the base layer 2 caused by the adhesive remaining on the surface thereof.

The configuration of the porous suction sheet of the present invention is not limited as long as it includes the base layer 2 and the surface layer 3, and the base layer 2 and the surface layer 3 are coupled together by the air-permeable adhesive layer 4 disposed between the base layer 2 and the surface layer 3. The porous suction sheet of the present invention may include an arbitrary layer in addition to the base layer 2, the surface layer 3, and the air-permeable adhesive layer 4. For example, the arbitrary layer is disposed on one surface of the base layer 2 opposite to the other surface facing the surface layer 3.

The replaceable surface layer of the present invention is composed of, for example, the surface layer 3 and the air-permeable adhesive layer 4 shown in FIG. 1. For ease of distribution, it is preferable that a separator film be additionally disposed in contact with the air-permeable adhesive layer 4. When such a replaceable surface layer is used, that is, when the old surface layer in the porous suction sheet is replaced by a new one, it is possible to peel the old surface layer from the base layer 2, remove the separator film to expose the air-permeable adhesive layer 4 on the new surface layer 3, and then laminate the new surface layer to the base layer 2 so that the base layer 2 and the air-permeable adhesive layer 4 contact each other.

### EXAMPLES

Hereinafter, the present invention will be described in more detail by way of examples. The present invention is not limited to the following examples.

First, the evaluation methods of porous suction sheets produced in Examples are shown. In a porous suction sheet used for holding and transferring a suction object such as a sheet-like article, whether or not the suction object is affected by suction is evaluated. In Examples, evaluations were performed not only on the influence of suction on the suction object but also the coupling strength (adhesive strength) between the base layer and the surface layer provided by the air-permeable adhesive layer and how much adhesive derived from the air-permeable adhesive layer remains in the surface layer when the surface layer is peeled from the base layer.

[Surface Roughness (Ra) of Surface Layer]

The surface roughness (Ra: arithmetic average roughness) of the surface layer was measured in accordance with JIS B 0601: 2001. Specifically, the surface roughness was measured using a stylus-type surface roughness meter “SURFCOM 550A” (Tokyo Seimitsu Co., Ltd.) under the following conditions: a stylus radius R of 250 μm, a measurement rate (X axis) of 0.3 mm/sec., and a measurement length of 8 mm. The average value of five measurements was taken as Ra.

[Influence of Suction on Suction Object]

The porous suction sheet thus produced was cut into pieces of 100 mm×100 mm, and then the piece of sheet was placed on the suction surface of the suction unit so that the base layer of the sheet and the suction surface contacted each other. Next, an aluminum foil with a thickness of 12 μm was placed on the surface layer of the sheet, and then a vacuum pump connected to the suction unit was operated to suck the aluminum foil onto the suction unit with the porous suction sheet interposed therebetween. Then, the surface of the aluminum foil at the time of suction was visually observed and whether or not the suction object was affected by the suction was evaluated.

[Coupling Strength (Adhesive Strength) between Base Layer and Surface Layer]

The coupling strength between the base layer and the surface layer of the produced porous suction sheet was measured in accordance with the “method for measuring the 180° peel adhesive strength” specified in JIS Z 0237.

[Proportion of Adhesive Remaining in Surface Layer When Surface Layer is Peeled from Base Layer]

The surface layer was peeled from the produced porous suction sheet in accordance with a peeling method defined in the “method for measuring the 180° peel adhesive strength” specified in JIS Z 0237, and after the peeling, the weight of the base layer and that of the surface layer were measured. Next, the base layer and the surface layer were each immersed in toluene overnight to remove the adhesive remaining in these layers. Next, the layers were taken from toluene and fully dried. Then, the weights of these layers were measured to obtain the differences in weight before and after the immersion, and to calculate, based on the differences, the proportion of the adhesive remaining in the surface layer when the surface layer was peeled from the base layer.

[Average Pore Diameter]

The average pore diameter of the base layer and that of the surface layer used for the production of the porous suction sheet were obtained by measuring the pore distributions of these layers using a mercury porosimeter “Autopore IV 9510” (Micromeritics Instrument Corporation) under the following conditions: a mercury intrusion pressure of about 4 kPa to 400 MPa, an increasing pressure measurement mode, and a measurement cell capacity of about 5 cm³.

Next, the methods for producing the base layer, the surface layer, and the air-permeable adhesive layer used for the production of the porous suction sheet are shown.

[Method A for Producing Surface Layer]

Ultrahigh molecular weight polyethylene (UHMWPE) powder having a viscosity average molecular weight of 4,500,000, water, a dispersing agent “Triton X-100” (Roche Applied Science), and a thickening agent (sodium carboxymethyl cellulose) were mixed together to obtain a dispersion of the powder. The mixing ratio (volume ratio) of these component materials, i.e., water, the UHMWPE powder, the dispersing agent, and the thickening agent was 100/60/5/2. Next, the dispersion thus obtained was applied onto a polyimide film having a surface roughness (Ra) of less than 0.1 μm using a doctor blade so as to form a coating layer of the dispersion. Next, the entire polyimide film including the coating layer formed thereon was placed in a drying machine set at 180° C. and left for 10 minutes to sinter the coating layer. Then, a laminate of the polyimide film and the porous sintered UHMWPE membrane formed by sintering the coating layer was removed from the drying machine and naturally cooled, and then the polyimide film was peeled from the porous sintered membrane. Next, the porous sintered membrane thus obtained was subjected to ultrasonic cleaning in distilled water to completely remove a surfactant serving as the dispersing agent from the membrane. Thus, a surface layer made of a porous body composed of UHMWPE fine particles that were bonded together was obtained.

[Method B for Producing Surface Layer]

A cylindrical mold with an outer diameter of 500 mm and a height of 600 mm was filled with UHMWPE powder having a viscosity average molecular weight of 9,000,000. This mold was placed in a metal pressure-resistant container and then the pressure inside the container was reduced to 1000 Pa. Next, heated steam was introduced into the pressure-resistant container to heat the mold at 165° C. under a pressure of 6 atmospheres for 6 hours, and then slowly cooled to obtain a cylindrical porous sintered body of UHMWPE. Next, the porous sintered body thus obtained was cut on a lathe to obtain a sheet. Next, the sheet thus obtained was subjected to heat treatment (hot pressing using a hot pressing machine: a pressing temperature of 130° C., a pressure of 3.0 kgf/cm², and a pressing time of 1 hour) to eliminate the stress of the sheet. Thus, a surface layer made of a porous body composed of UHMWPE fine particles that were bonded together was obtained.

[Method A for Producing Base Layer]

A cylindrical porous sintered body of UHMWPE was obtained according to the method A for producing a surface layer. Next, the porous sintered body thus obtained was cut on a lathe to obtain a sheet. Next, the sheet thus obtained was subjected to heat treatment (hot pressing using a hot pressing machine: a pressing temperature of 130° C., a pressure of 3.0 kgf/cm², and a pressing time of 1 hour) to eliminate the stress of the sheet. Thus, a base layer made of a porous body composed of UHMWPE fine particles that were bonded together was obtained.

[Method B for Producing Base Layer]

A mold having a rectangular parallelepiped interior space of 100 mm long, 100 mm wide, and 1.8 mm deep was filled with UHMWPE powder having a viscosity average molecular weight of 5,000,000. A metal plate was fixed to the open end of the mold to hermetically seal the mold. The inner surface of the mold and the surface of the metal plate facing the interior of the mold were previously subjected to release treatment. Next, the hermetically sealed mold was heated and pressed at a temperature of 160° C. under a pressure of 0.49 MPa for 5 minutes. Then, the mold was slowly cooled to room temperature, and thus a base layer made of a porous body composed of UHMWPE fine particles that were bonded together was obtained.

[Method A for Producing Air-permeable Adhesive Layer]

A hot melt adhesive “Hirodine 5132” (Yasuhara Chemical Co., Ltd.) heated at 180° C. was sprayed uniformly onto the surface of a polyester film “RT-75G” (Nitto Denko Corporation) serving as a release film at a pressure of 0.49 MPa to form a grid pattern. Thus, an air-permeable adhesive layer was produced.

### Example 1

A surface layer with a thickness of 200 μm was produced using UHMWPE powder having an average particle diameter of 35 μm according to the method A for producing a surface layer. In producing the surface layer, the thickness of the coating layer was 400 μm.

Separately from this surface layer, a base layer with a thickness of 1.8 mm was produced using UHMWPE powder having an average particle diameter of 150 μm according to the method A for producing a base layer. The cutting thickness was set to 1.8 mm.

Next, an air-permeable adhesive layer was produced according to the method A for producing an air-permeable adhesive layer. In producing the air-permeable adhesive layer, the amount of a hot melt adhesive applied to a release film was 10 g/m². Subsequently, the surface layer produced as described above was laminated to the air-permeable adhesive layer thus produced at a pressure of 0.1 MPa. Next, the release film was peeled from the air-permeable adhesive layer, and then the base layer produced as described above was laminated to the air-permeable adhesive layer from which the release film had been peeled. Thus, a porous suction sheet was obtained.

### Example 2

A porous suction sheet was obtained in the same manner as in Example 1, except that UHMWPE powder having an average particle diameter of 75 μm was used to produce a surface layer.

### Example 3

A porous suction sheet was obtained in the same manner as in Example 1, except that an air-permeable adhesive layer was produced by applying 5 g/m² of hot melt adhesive to a release film.

### Example 4

A porous suction sheet was obtained in the same manner as in Example 1, except that a base layer with a thickness of 1.8 mm was produced according to the method B for producing a base layer and using UHMWPE powder having an average particle diameter of 75 μm.

### Example 5

A porous suction sheet was obtained in the same manner as in Example 1, except that an air-permeable adhesive layer was produced by applying 50 g/m² of hot melt adhesive to a release film.

### Example 6

A porous suction sheet was obtained in the same manner as in Example 1, except that an air-permeable adhesive layer was produced by applying 30 g/m² of hot melt adhesive to a release film.

### Comparative Example 1

A surface layer with a thickness of 200 μm was produced according to the method B for producing a surface layer and using UHMWPE powder having an average particle diameter of 120 μm. In producing the surface layer, the cutting thickness was set to 200 μm.

Separately from this surface layer, a base layer with a thickness of 1.8 mm was produced according to the method B for producing a base layer and using UHMWPE powder having an average particle diameter of 75 μm.

Next, an air-permeable adhesive layer was produced according to the method A for producing an air-permeable adhesive layer. In producing the air-permeable adhesive layer, the amount of a hot melt adhesive applied to a release film was 2.5 g/m². Subsequently, the surface layer produced as described above was laminated to the air-permeable adhesive layer thus produced at a pressure of 0.1 MPa. Next, the release film was peeled from the air-permeable adhesive layer, and then the base layer produced as described above was laminated to the air-permeable adhesive layer from which the release film had been peeled. Thus, a porous suction sheet was obtained.

### Comparative Example 2

UHMWPE powder having an average particle diameter of 35 μm was mixed with glycerin and a surfactant to prepare a dispersion of the powder. The solid content of the dispersion was adjusted to 40% by volume. Next, the dispersion thus prepared was applied onto a corona-treated polyimide film (Kapton 100H) using an applicator. The thickness of the coating layer (including the solvent) formed by the application was 100 μm.

Next, immediately after the formation of the coating layer, the base layer produced in the same manner as in Example 1 was placed on the coating layer thus formed. Subsequently, the polyimide film was placed on one surface of the base layer opposite to the other surface on which the coating layer was formed. Thus, a laminate of the polyimide film, the coating layer, the base layer, and the polyimide film was obtained. This laminate was placed in a drying machine set at 150° C. and left for 30 minutes. Then, the laminate was removed from the drying machine and naturally cooled to room temperature. Next, the polyimide films were peeled from both surfaces of the laminate, and the laminate from which the polyimide films had been peeled was immersed in ethyl alcohol to extract the dispersion medium of the UHMWPE powder remaining in the laminate. For efficient extraction of the dispersion medium, the laminate and ethyl alcohol were subjected to ultrasonic vibration. Then, ethyl alcohol was evaporated at room temperature, and thus a porous suction sheet was obtained.

Tables 1 and 2 collectively show the evaluation results of the porous suction sheets produced in Examples 1 to 6 and Comparative Examples 1 and 2, including the average pore diameters of the respective layers produced therein. In the column of “influence on suction object” in Table 2, “good (o)” indicates that no distortion was observed in the aluminum foil as a suction object, and “poor (x)” indicates that distortion was observed in the aluminum foil as a suction object.

TABLE 1

| | Average pore |
|---|---|
| | diameter [μm] |
| Surface layers of Examples 1, 3, 4, 5, and 6 | 11 |
| Base layers of Examples 1, 2, 3, 5, and 6 | 39 |
| Surface layer of Example 2 | 18 |
| Base layers of Example 4 and Com. Example 1 | 18 |
| Surface layer of Com. Example 1 | 30 |

TABLE 2

| | | | | Amount of |
|---|---|---|---|---|
| | | | Interlayer | adhesive |
| | Surface | Influence | coupling | remaining |
| | roughness | on suction | strength | in surface |
| | Ra [μm] | object | [N/25 mm] | layer [%] |
| Example 1 | 0.3 | Good (∘) | 1.0 | 82 |
| Example 2 | 0.9 | Good (∘) | 1.0 | 71 |
| Example 3 | 0.3 | Good (∘) | 0.6 | 82 |
| Example 4 | 0.3 | Good (∘) | 1.0 | 63 |
| Example 5 | 0.3 | Good (∘) | 5.0 | 78 |
| Example 6 | 0.3 | Good (∘) | 3.0 | 79 |
| Com. Example 1 | 1.4 | Poor (x) | 0.3 | 42 |
| Com. Example 2 | 0.3 | Good (∘) | Unmeasurable | — |

As shown in Table 2, in each of Examples 1 to 6 and Comparative Example 2 in which one principal surface of the surface layer that is to contact a suction object has a surface roughness (Ra) of 1.0 μm or less (0.9 μm or less based on the value of Example 2), no distortion was observed in the aluminum foil as the suction object, and the suction was well performed. In contrast, in Comparative Example 1 in which one principal surface of the surface layer that is to contact a suction object has a surface roughness (Ra) of 1.4 μm, distortion was observed in the aluminum foil as the suction object.

In each of Examples 1 to 6 in which the coupling strength (interlayer coupling strength) between the base layer and the surface layer is 0.5 N/25 mm or more (0.6 N/25 mm or more based on the value of Example 3), defects such as delamination and lifting were not observed between the base layer and the surface layer and their coupling was well maintained when the aluminum foil was sucked. In contrast, in Comparative Example 1 in which the interlayer coupling strength is 0.3 N/25 mm, slight lifting was observed between the base layer and the surface layer due to the suction of the aluminum foil. Thus, good coupling between these layers was not maintained when the suction object was sucked.

It is confirmed that in each of Examples 1 to 6 in which the average pore diameter of the surface layer is smaller than that of the base layer, the adhesive was more likely to remain in the surface layer when the surface layer was peeled from the base layer. It is also confirmed that in Comparative Example 1 in which the average pore diameter of the surface layer is larger than that of the base layer, in contrast, the adhesive was more likely to remain in the base layer when the surface layer was peeled from the base layer.

Next, in each of Examples 1 to 6 and Comparative Example 2 in which the influence on the suction object was rated good, after the surface layer was peeled from the base layer, another surface layer of the same type was laminated to the base layer so as to produce a porous suction sheet again. The porous suction sheets thus produced were subjected to the aluminum foil suction test mentioned above. As a result, the aluminum foil could be sucked to each of these porous suction sheets without any distortion. In addition, defects such as delamination and lifting were not observed between the base layer and the surface layer when the aluminum foil was sucked. In Example 5, however, a phenomenon in which the surface layer was slightly stretched in the process of peeling the surface layer from the base layer was observed, although the surface layer could be replaced without any difficulty. Therefore, probably the interlayer coupling strength of Example 5 is almost the upper limit at which the surface layer can be replaced. On the other hand, in Comparative Example 2 in which the surface layer was disposed on the base layer by heat treatment, the surface layer and the base layer were fused together. Therefore, the surface layer could neither be peeled from the base layer nor replaced by a new one.

### INDUSTRIAL APPLICABILITY

The porous suction sheet of the present invention can be used in the same applications as conventional porous suction sheets. For example, the porous suction sheet of the present invention can be used for suction and holding or suction and transfer of plate-like or sheet-like articles such as glass sheets (for example, glass substrates for liquid crystal display devices), semiconductor wafers, and ceramic green sheets.

The present invention is applicable to other embodiments as long as they do not depart from the spirit or essential characteristics thereof. The embodiments disclosed in this description are to be considered in all respects as illustrative and not limiting. The scope of the invention is indicated by the appended claims rather than by the foregoing description, and all changes which come within the meaning and range of equivalency of the claims are intended to be embraced therein.

1. A porous suction sheet that prevents contact between a suction object and a suction surface of a suction unit when the sheet is disposed on the suction surface, the porous suction sheet comprising:
a base layer having air permeability; and
a surface layer disposed on the base layer, wherein
the surface layer is made of a porous body composed of resin fine particles that are bonded together,
one principal surface of the surface layer opposite to the other principal surface facing the base layer has a surface roughness (Ra) of 1.0 μm or less, and
the base layer and the surface layer are coupled together by an air-permeable adhesive layer disposed between the base layer and the surface layer.

2. The porous suction sheet according to claim 1, wherein the resin fine particles are ultrahigh molecular weight polyethylene fine particles.

3. The porous suction sheet according to claim 1, wherein the base layer is made of ultrahigh molecular weight polyethylene.

4. The porous suction sheet according to claim 1, wherein a coupling strength between the base layer and the surface layer provided by the air-permeable adhesive layer is 0.5 N/25 mm or more and 5.0 N/25 mm or less.

5. The porous suction sheet according to claim 1, wherein
the base layer is made of a porous body, and
an average pore diameter of the surface layer is smaller than that of the base layer.

6. The porous suction sheet according to claim 1, wherein a thickness of the surface layer is smaller than that of the base layer.

7. A replaceable surface layer used in a porous suction sheet, the porous suction sheet preventing contact between a suction object and a suction surface of a suction unit when the sheet is disposed on the suction surface, the surface layer being used to form the porous suction sheet by being coupled to a base layer having air permeability, and the surface layer serving as a surface of the formed porous suction sheet that contacts the suction object when the porous suction sheet is disposed on the suction surface, wherein
the surface layer is made of a porous body composed of resin fine particles that are bonded together,
an air-permeable adhesive layer is disposed on one principal surface of the surface layer so as to couple the surface layer and the base layer together, and
the other principal surface of the surface layer has a surface roughness (Ra) of 1.0 μm or less.
